(19) United States
(12) Patent Application Publication
(10) Pub. No.: US 2006/0214753 A1
(43) Pub. Date: Sep. 28, 2006

(54) Linear actuator

(75) Inventors: Toyohisa Yamada, Aichi (JP); Hideo Mita, Aichi (JP); Motohiro Igarasi, Aichi (JP); Takeshi Okutomi, Aichi (JP); Katsuyuki Kuwano, Aichi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignees: AISIN SEIKI KABUSHIKI KAISHA, AICHI (JP); CENTRAL JAPAN RAILWAY COMPANY, AICHI (JP)

(21) Appl. No.: 10/540,882

(22) PCT Filed: Dec. 25, 2003
(86) PCT No.: PCT/JP03/16683

§ 371 Date: Mar. 9, 2006

(30) Foreign Application Priority Data
Dec. 25, 2002 (JP) 2002-375461

(51) Int. Cl. H01F 7/08

(52) U.S. Cl. 335/229

(57) ABSTRACT

A linear actuator, in which a plurality of electromagnets where coils are wound around magnetic materials are provided so as to face each other in a manner where the polarities N and S of the electromagnets alternate at the time of excitation, and magnetic poles of a plurality of permanent magnets that are aligned so as to form a movable member are placed in positions that face the plurality of magnetic poles, in which the permanent magnets extend beyond the portions where the magnetic poles of the electromagnets are provided so as to face and therefore effects are attained that a stable force of magnetic attraction in the direction of the stroke is obtained and peeling and cracking of the permanent magnet are prevented.

### TECHNICAL FIELD

The present invention relates to a linear actuator.

### BACKGROUND ART

A first conventional linear actuator is formed of a stator iron core F which supports a movable part K where a permanent magnet M has been fixed to the outer peripheral surface and a coil CL, and which forms a magnetic pole PL, as shown in FIG. 18, and to which one or more magnetizers in ring form that extend in the direction of the diameter are layered in the direction of the axis, wherein the length of the permanent magnet M in the direction of the axis is the same as the stroke of the axis as a movable part K. (For example, Patent Document 1: Japanese Patent Application Laid-Open (kokai) No. H05-22920; pages 2-3, FIG. 1, FIG. 4, FIG. 6)

In a concrete example where the above-mentioned first conventional linear actuator is applied to an actuator for a pressure wave generator, as shown in FIG. 19, a piston P that reciprocates within a cylinder C is linked to a movable part K where a permanent magnet M is provided so as to face magnetic pole PL of stator iron core F around which coil CL is wound.

A conventional iron core movable type linear vibrator is formed, as shown in FIG. 20, of a stator iron core F to which coil CL for generating an alternative magnetic field is secured, a movable iron core K in approximately inverted C form that has been placed so as to face this stator iron core F with a space in between, and a plurality of permanent magnets M which are aligned on the surface of the stator iron core F that faces the movable iron core K, in a manner where magnets that are magnetized in the direction of the magnetic flux of the coil and magnets that are magnetized in the opposite direction are aligned alternately. (For example, Patent Document 2: Japanese Patent Application Laid-Open (kokai) No. H11-187638; pages 2-5, FIG. 1, FIG. 2)

Problems arise with the above-mentioned first conventional linear actuator and the iron core movable linear vibrator, such that the components of the magnetic flux in the direction perpendicular to the stroke increase more than those of the magnetic flux in the direction of the stroke and a decrease of force of magnetic attraction in the direction of the stroke would be occurred at a position, in terms of the components of the magnetic fluxes in the direction of the stroke and in the direction perpendicular to the stroke between the magnetic pole on the iron core side and the magnetic pole on the permanent magnet side, as the movable part K moves, and at the same time, it is necessary that permanent magnets M are bounded by means of an adhesive, and the bonded permanent magnets easily peel.

### DISCLOSURE OF THE INVENTION

In view of the foregoing, the present inventor have conceived a technical idea of the present invention such that, in a linear actuator, wherein a plurality of electromagnets where coils are wound around magnetic materials are provided so as to face each other in a manner where the polarities N and S of the electromagnets alternate at the time of excitation, and magnetic poles of a plurality of permanent magnets that are aligned so as to form a movable member are placed in positions that face the plurality of magnetic poles, wherein the permanent magnets extend beyond the portions where the magnetic poles of the electromagnets are provided so as to face, a magnetic flux is formed so as to pass the permanent magnets in the portions other than those where the magnetic poles of the electromagnets and the magnetic poles of the permanent magnets face each other so that an axis propelling force is generated.

An object of the present invention is to attain a stable force of magnetic attraction in the direction of the stroke and to prevent permanent magnets from easily peeling and cracking.

The present invention (the first invention described in Claim 1) provides a linear actuator, wherein a plurality of electromagnets where coils are wound around magnetic materials are provided so as to face each other in a manner where the polarities N and S of the electromagnets alternate at the time of excitation, and magnetic poles of a plurality of permanent magnets that are aligned so as to form a movable member are placed in positions that face the plurality of magnetic poles, wherein the permanent magnets extend beyond the portions where the magnetic poles of the electromagnets are provided so as to face.

The present invention (the second invention described in Claim 2) according to the first invention provides a linear actuator wherein a notch is formed on a portion in the direction of the axis of the magnetic poles of the electromagnets that face the magnetic poles of the permanent magnets, so that a magnetic flux is formed so as to pass the permanent magnets in the portions other than those where the magnetic poles of the electromagnets and the magnetic poles of the permanent magnets face each other.

The present invention (the third invention described in Claim 3) according the second invention provides a linear actuator wherein three permanent magnets are aligned between the magnetic poles of the adjacent electromagnets.

The present invention (the fourth invention described in Claim 4) according to the third invention provides a linear actuator wherein the magnetic poles of one permanent magnet are placed so as to span the magnetic poles of the adjacent electromagnets at the time of full stroke.

The present invention (the fifth invention described in Claim 5) provides a linear actuator, wherein magnetic poles of a plurality of electromagnets where coils are wound around magnetic materials are aligned in a manner where the polarities N and S alternate at the time of excitation, and magnetic poles of permanent magnets of which the number is smaller than the number of magnetic poles of the electromagnets by 1 are aligned in positions that face the magnetic poles of the electromagnets, magnetic gaps are provided between the respective magnetic poles of the electromagnets on the side that faces the permanent magnets, and the magnetic poles of the permanent magnets are arranged so that one magnetic pole of the permanent magnets spans between the respective magnetic poles of the electromagnets at the time of full stroke.

The present invention (the sixth invention described in Claim 6) according to the fifth invention provides a linear actuator wherein permanent magnets of which the magnetic poles are opposite that of adjacent permanent magnets are placed in positions adjacent to the permanent magnets, in a position that faces an end magnetic pole in the direction of the axis of the lane or column of the magnetic poles of the electromagnets on the side that faces the permanent magnets, and at least a portion of the permanent magnets extends to the outside of the end portion of the lane or column of the magnetic poles of the electromagnets at the time of full stroke.

The present invention (the seventh invention described in Claim 7) according to the sixth invention provides a linear actuator wherein a notch is provided at the center of the magnetic poles of the electromagnets on the side that faces the permanent magnets, so that a magnetic gap is provided.

The present invention (the eighth invention described in Claim 8) according to the seventh invention provides a linear actuator wherein a magnetic gap is provided between the adjacent permanent magnets.

The present invention (the ninth invention described in Claim 9) according to the eighth invention provides a linear actuator wherein magnetic materials are placed between the respective magnetic poles of the electromagnets on the side that does not face the permanent magnets, so that a magnetic circuit which connects the respective magnetic poles is provided.

The present invention (the tenth invention described in Claim 10) according to the ninth invention provides a linear actuator wherein a support member is provided on the outer surface of the permanent magnets, so as to fix the permanent magnets.

The present invention (the eleventh invention described in Claim 11) according to the tenth invention provides a linear actuator wherein the support member is formed of a magnetic material, so that the density of the magnetic flux between the permanent magnets and the electromagnets is increased.

The present invention (the twelfth invention described in Claim 12) according to the fifth invention provides a linear actuator being an actuator for a pressure wave generator.

In the linear actuator of the first invention having the above-described construction, a plurality of electromagnets where coils are wound around magnetic materials are provided so as to face each other in a manner where the polarities N and S of the electromagnets alternate at the time of excitation, and magnetic poles of a plurality of permanent magnets that are aligned so as to form a movable member are placed in positions that face the plurality of magnetic poles, wherein the permanent magnets extend beyond the portions where the magnetic poles of the electromagnets are provided so as to face.

Therefore, a magnetic flux that passes through the above-described permanent magnet is formed, and generating an axis propelling force, and whereby, an effect is attained where a stable force of magnetic attraction in the direction of the stroke is implemented or obtained.

In the linear actuator of the second invention having the above-described construction according to the first invention, the notch is formed on a portion in the direction of the axis of the magnetic poles of the electromagnets that face the magnetic poles of the permanent magnets, so that a magnetic flux is formed so as to pass the permanent magnets in the portions other than those where the magnetic poles of the electromagnets and the magnetic poles of the permanent magnets face each other.

Forming of the flux which passes the permanent magnets in the portions other than those where the magnetic poles of the electromagnets and the magnetic poles of the permanent magnets face each other is promoted, therefore, the linear actuator of the second invention achieve the effect of improving an axis propelling force.

In the linear actuator of the third invention having the above-described construction according to the second invention, three permanent magnets are aligned between the magnetic poles of the adjacent electromagnets.

Therefore, the linear actuator of the third invention achieves the effect that the stable reciprocating movement of the movable member where magnetic poles of the permanent magnets are placed is accomplished.

In the linear actuator of the fourth invention having the above-described construction according to the third invention, the magnetic poles of one permanent magnet are placed so as to span the magnetic poles of the adjacent electromagnets at the time of full stroke.

Therefore, the linear actuator of the fourth invention achieves the effect that stable reciprocating movement of the movable member is accomplished.

In the linear actuator of the fifth invention having the above-described construction, magnetic poles of a plurality of electromagnets where coils are wound around magnetic materials are aligned in a manner where the polarities N and S alternate at the time of excitation, and magnetic poles of permanent magnets of which the number is smaller than the number of magnetic poles of the electromagnets by 1 are aligned in positions that face the magnetic poles of the electromagnets, magnetic gaps are provided between the respective magnetic poles of the electromagnets on the side that faces the permanent magnets, and the magnetic poles of the permanent magnets are arranged so that one magnetic pole of the permanent magnets spans between the respective magnetic poles of the electromagnets at the time of full stroke.

Therefore, the magnetic flux is formed so as to pass the permanent magnets provided in the above-mentioned magnetic gaps in the portions other than those where the magnetic poles of the electromagnets and the magnetic poles of the permanent magnets face each other, generating an axis propelling force, and thereby, an effect is attained where a stable force of magnetic attraction in the direction of the stroke is obtained.

In the linear actuator of the sixth invention having the above-described construction according to the fifth invention, permanent magnets of which the magnetic poles are opposite that of adjacent permanent magnets are placed in positions adjacent to the permanent magnets, in a position that faces an end magnetic pole in the direction of the axis of the lane of the magnetic poles of the electromagnets on the side that faces the permanent magnets, and at least a portion of the permanent magnets extends to the outside of the end portion of the lane of the magnetic poles of the electromagnets at the time of full stroke.

Therefore, the magnetic flux is formed so as to pass the permanent magnet provided outside of the end portion of the lane of the magnetic poles of the electromagnets, generating an axis propelling force, and thereby, an effect is attained where a stable force of magnetic attraction in the direction of the stroke is obtained.

In the linear actuator of the seventh invention having the above-described construction according to the sixth invention, a notch is provided at the center of the magnetic poles of the electromagnets on the side that faces the permanent magnets, so that a magnetic gap is provided.

Therefore, the disproportionate magnetic flux is formed around the notch provided at the center of the magnetic poles, and the linear actuator of the seventh invention attains an effect to enhance an axial propelling force.

In the linear actuator of the eighth invention having the above-described construction according to the seventh invention, a magnetic gap is provided between the adjacent permanent magnets.

Therefore, an effect is attained where the magnetic flux which passes the above-mentioned permanent magnets is improved to be formed.

In the linear actuator of the ninth invention having the above-described construction according to the eighth invention, magnetic materials are placed between the respective magnetic poles of the electromagnets on the side that does not face the permanent magnets, so that a magnetic circuit which connects the respective magnetic poles is provided.

Therefore, a magnetic flux is accelerated to be formed so as to pass the permanent magnets in the portions other than those where the magnetic poles of the electromagnets and the magnetic poles of the permanent magnets face each other. The linear actuator of the ninth invention has the effect to increase an axial propelling force.

In the linear actuator of the tenth invention having the above-described construction according to the ninth invention, a support member is provided on the outer surface of the permanent magnets, so as to fix the permanent magnets.

Therefore, the linear actuator of the tenth invention attains an effect to prevent permanent magnets from peeling and cracking.

In the linear actuator of the eleventh invention having the above-described construction according to the tenth invention, the support member is formed of the magnetic material, so that the density of the magnetic flux between the permanent magnets and the electromagnets is increased.

Therefore, the linear actuator of the eleventh invention attains an effect to increase an axis propelling force generated, and to gain more stable force of magnetic attraction in the direction of the stroke.

In the linear actuator of the twelfth invention having the above-described construction according to the fifth invention, a linear actuator is applied as an actuator for a pressure wave generator.

Therefore, the linear actuator of the twelfth invention attains an effect that it is possible to generate a stable pressure wave.

### BRIEF DESCRIPTION OF THE DRAWINGS

FIG. 1 is a sectional diagram showing the basic construction of the linear actuator of the first and second embodiments according to the present invention.

FIG. 2 is a sectional diagram of the linear actuator, at the time of full stroke, of the present first and second embodiments.

FIG. 3 is an explanatory diagram explaining the distribution of lines of magnetic force according to the linear actuator of the present embodiment.

FIG. 4 is an explanatory diagram explaining the influence on the distribution of lines of magnetic force due to the portion of a notch according to the linear actuator of the present embodiment.

FIG. 5 is an explanatory diagram explaining the influence on the distribution of lines of magnetic force due to the portion of a notch according to the linear actuator of the present embodiment.

FIG. 6 is an explanatory diagram explaining the distribution of lines of magnetic force in stroke in the case of having no intermediate permanent magnet according to the linear actuator of the present embodiment.

FIG. 7 is an explanatory diagram explaining the distribution of lines of magnetic force in stroke in the case of having no intermediate permanent magnet according to the linear actuator of the present embodiment.

FIG. 8 is an explanatory diagram explaining the distribution of lines of magnetic force in stroke in the case of having no intermediate permanent magnet according to the linear actuator of the present embodiment.

FIG. 9 is an explanatory diagram explaining the distribution of lines of magnetic force in stroke in the case of having no intermediate permanent magnet according to the linear actuator of the present embodiment.

FIG. 10 is an explanatory diagram explaining the distribution of lines of magnetic force in stroke in the case of having no intermediate permanent magnet according to the linear actuator of the present embodiment.

FIG. 11 is an explanatory diagram explaining the distribution of lines of magnetic force in stroke in the case of having an intermediate permanent magnet according to the linear actuator of the present embodiment.

FIG. 12 is an explanatory diagram explaining the distribution of lines of magnetic force in stroke in the case of having an intermediate permanent magnet according to the linear actuator of the present embodiment.

FIG. 13 is an explanatory diagram explaining the distribution of lines of magnetic force in stroke in the case of having an intermediate permanent magnet according to the linear actuator of the present embodiment.

FIG. 14 is an explanatory diagram explaining the distribution of lines of magnetic force in stroke in the case of having an intermediate permanent magnet according to the linear actuator of the present embodiment.

FIG. 15 is a sectional diagram showing the detail construction of the linear actuator of the second embodiment according to the present invention.

FIG. 16 is a cross-sectional diagram showing the detail construction of the linear actuator of the second embodiment.

FIG. 17 is a sectional diagram showing the detail construction of an applied example of an actuator for pressure wave generating device to which the linear actuator of the second embodiment is applied.

FIG. 18 is a sectional diagram showing the first conventional linear actuator.

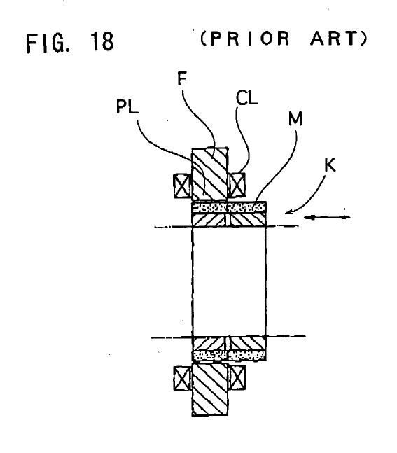

FIG. 19 is a sectional diagram showing an applied example of an actuator for pressure wave generating device to which the first conventional linear actuator is applied.

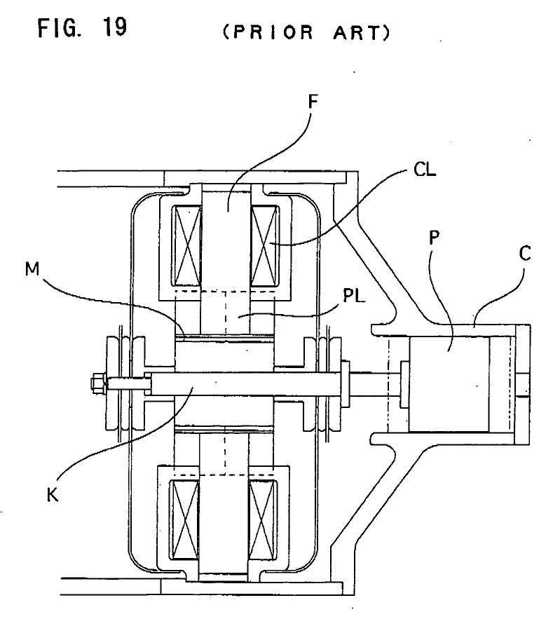

FIG. 20 is a sectional diagram showing the conventional iron core movable linear vibrator.

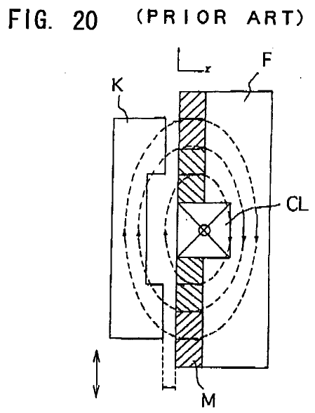

### BEST MODE FOR CARRYING OUT THE INVENTION

Embodiments of the present invention will now be described with reference to the drawings.

### First Embodiment

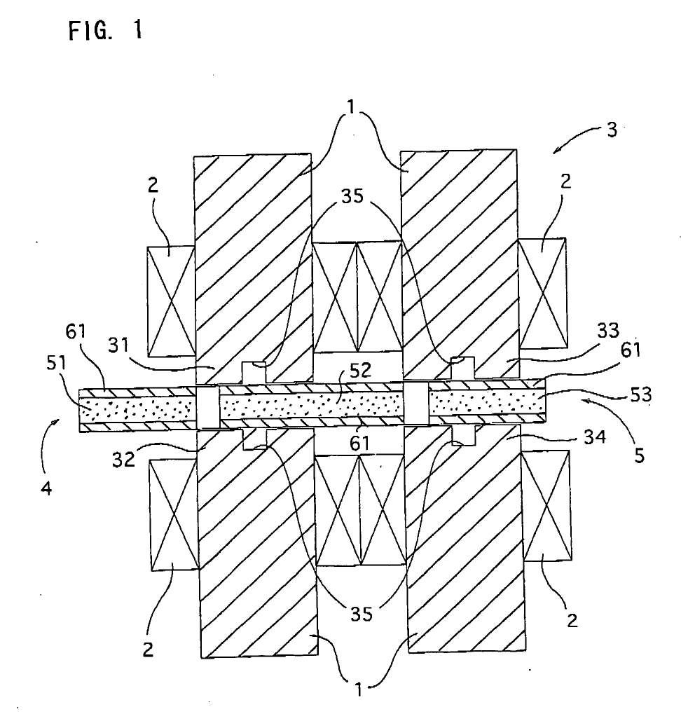

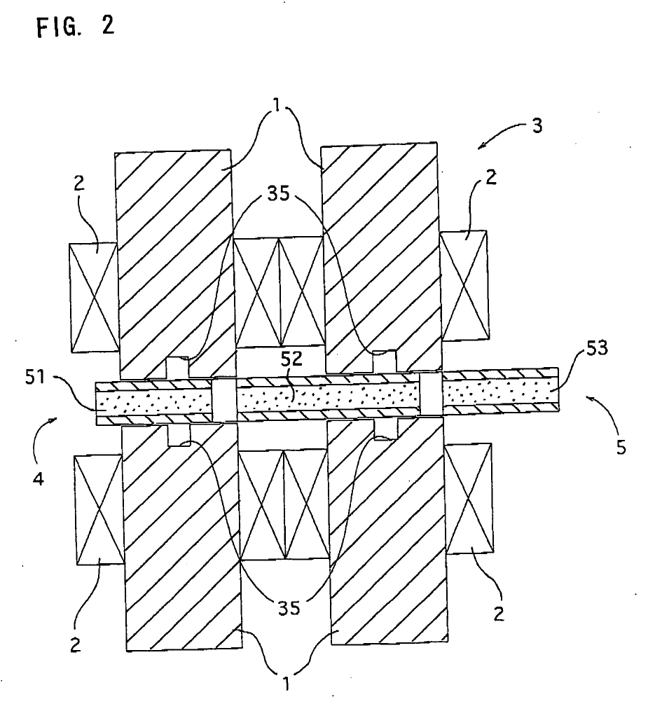

A linear actuator according to the present first embodiment is, as shown in FIG. 1 and FIG. 2, a linear actuator wherein a plurality of magnetic poles 31, 32, 33 and 34 of electromagnet 3 where coil 2 is wound around iron core 1 of a magnetic material are provided so that polarities N and S alternate at the time of excitation, the magnetic poles of a plurality of permanent magnets which are aligned so as to form movable member 4 are placed in positions that face the plurality of magnet poles, and the permanent magnets 5 extend beyond portions that face portions where the magnetic poles 31, 32, 33 and 34 of the electromagnet 3 are provided.

Notches 35 are formed in portions in the direction of the axis of magnetic poles 31, 32, 33 and 34 of the electromagnet 3 that face the magnetic poles of the permanent magnets 5, so that a magnetic flux is formed so as to pass through the permanent magnets 5 in portions other than the portions where magnetic poles 31, 32, 33 and 34 of the electromagnet 3 and the magnetic poles of the permanent magnets 5 face each other.

Three permanent magnets 51, 52 and 53 are aligned between magnet poles 31, 32, 33 and 34 of the adjacent electromagnet 3, and magnetic poles of one permanent magnet 5 are arranged so as to span or sit astride between magnetic poles 31, 32, 33 and 34 of the adjacent electromagnet 3 at the time of full stroke, shown in FIG. 2.

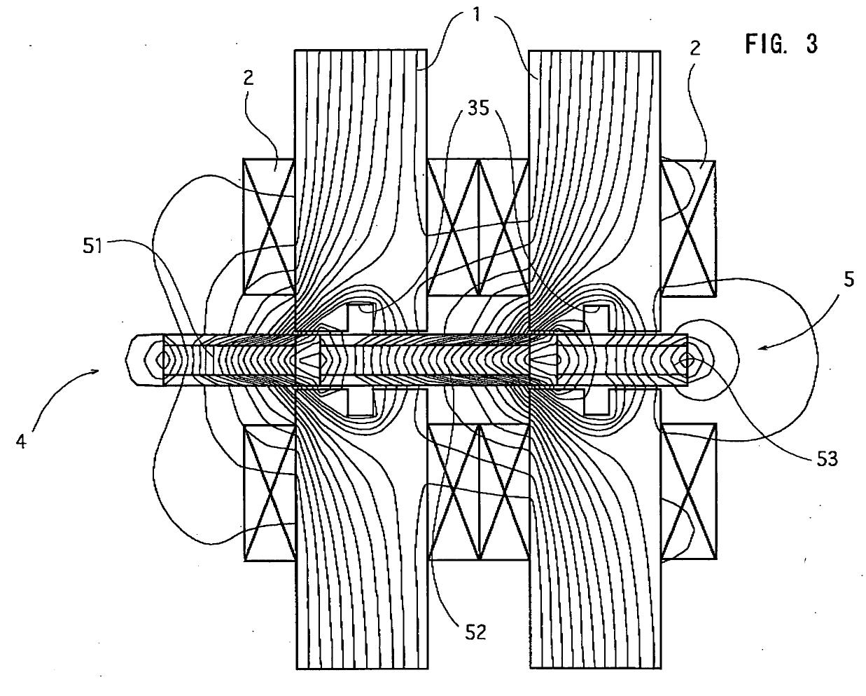

Lines of magnetic force between two members (magnetic poles 31, 32, 33 and 34 of the electromagnet 3, and three permanent magnets 51, 52 and 53) come out perpendicularly from the surface of the respective members, as shown in FIG. 3, and do not cross each other, making the length of the lines of magnetic force the shortest.

The force of magnetic attraction between two members (magnetic poles 31, 32, 33 and 34 of the electromagnet 3, and three permanent magnets 51, 52 and 53) works as a result of properties that make the length of these lines of magnetic force the shortest.

The force of magnetic attraction has properties such that the greater the amount of lines of magnetic force is, the greater the force of magnetic attraction, and the smaller the amount of lines of magnetic force is, the smaller the force of magnetic attraction.

Unless the surfaces of the members on both ends of the lines of magnetic force are parallel to each other, the force of magnetic attraction resulting from these lines of magnetic force has a component of a direction as a vector.

In the present first embodiment, the permanent magnets 5 extend or elongate beyond the portions that face magnetic poles 31, 32, 33 and 34 of the electromagnet 3, as shown in FIG. 1 and FIG. 2, and therefore, a magnetic flux that passes through the permanent magnets 5 in portions other than the portions (magnetic poles) where magnetic poles 31, 32, 33 and 34 of the electromagnet 3 and the permanent magnets 5 face each other, as shown in FIG. 3. Namely, constant lines of magnetic force that generate a force of magnetic attraction pass through the portions of the permanent magnets 5 that do not face magnetic poles 31, 32, 33 and 34, and therefore, constant lines of magnetic force that generate a force of magnetic attraction are secured or maintained in permanent magnets 5, in portions other than the portions that face magnetic poles 31, 32, 33 and 34 of the electromagnet 3, irrespective of the movement of the permanent magnets 5. Therefore, constant lines of magnetic force that generate a force of magnetic attraction are secured, irrespective of the movement of the permanent magnets, and therefore, a constant force of magnetic attraction is secured or obtained.

In addition, in the present first embodiment, as shown in FIG. 1 and FIG. 2, notches 35 are formed so as to form non-magnetic spaces in portions of magnetic pole ends 31, 32, 33 and 34 of electromagnet 3, and therefore, comparison is carried out between the case where notches (non-magnetic spaces) exist and the case where notches do not exist.

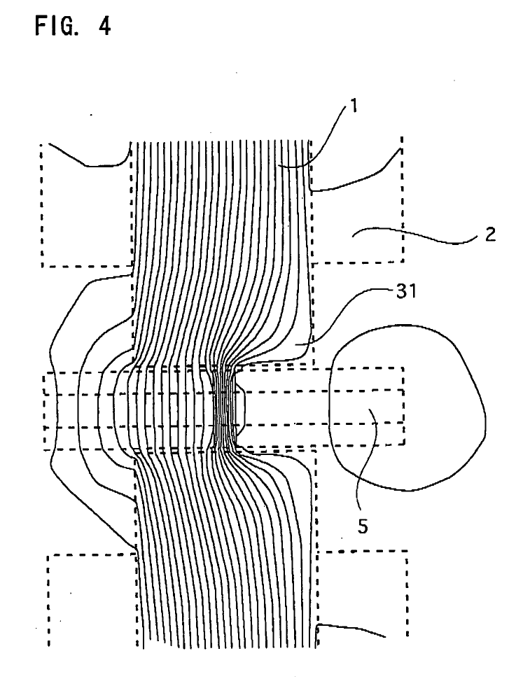

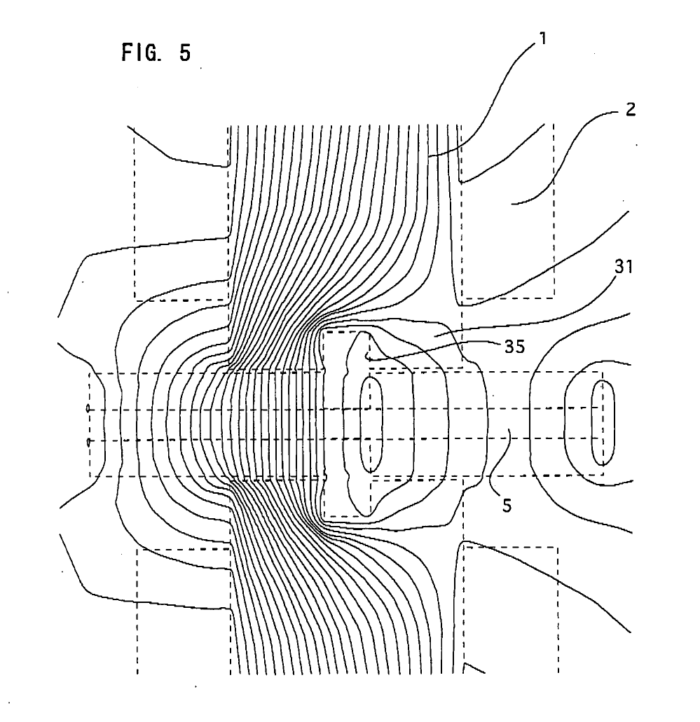

In the case where notches 35 exist, as shown in FIG. 5, a magnetic flux created by the electromagnet 3 bypasses notches 35, so that distribution of the magnetic flux is biased, while the amount of magnetic flux, that passes through the portions of permanent magnets that do not face the magnetic poles of the electromagnet increases, and therefore, the force of magnetic attraction becomes great when notches (non-magnetic spaces) 35 are formed, in comparison with the case where there are no notches, as shown in FIG. 4.

Furthermore, in the present first embodiment, as shown in FIG. 1 and FIG. 2, a plurality of magnetic poles 31, 32, 33 and 34 of electromagnet 3 are provided so as to face each other with gaps of which the distance is the same as or close to the length of the stroke of the movable member 4, and one permanent magnet 52 is placed so as to span or bridge between magnetic poles 31, 32, 33 and 34 of the electromagnet 3, which become adjacent to each other at the time of full stroke shown in FIG. 2, and therefore, a comparison is carried out between the case where middle permanent magnet 52 exists and the case where middle permanent magnet 52 does not exist.

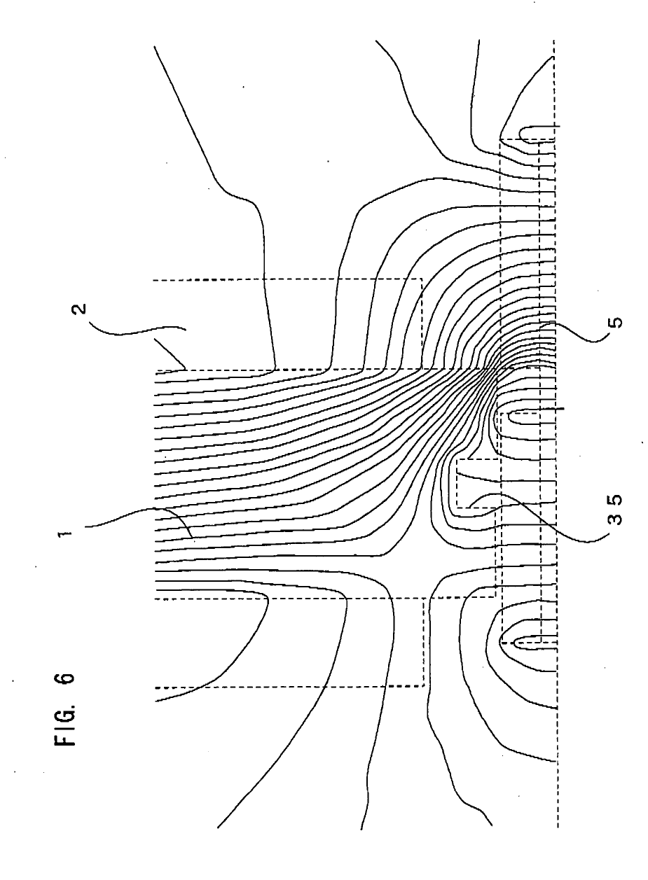

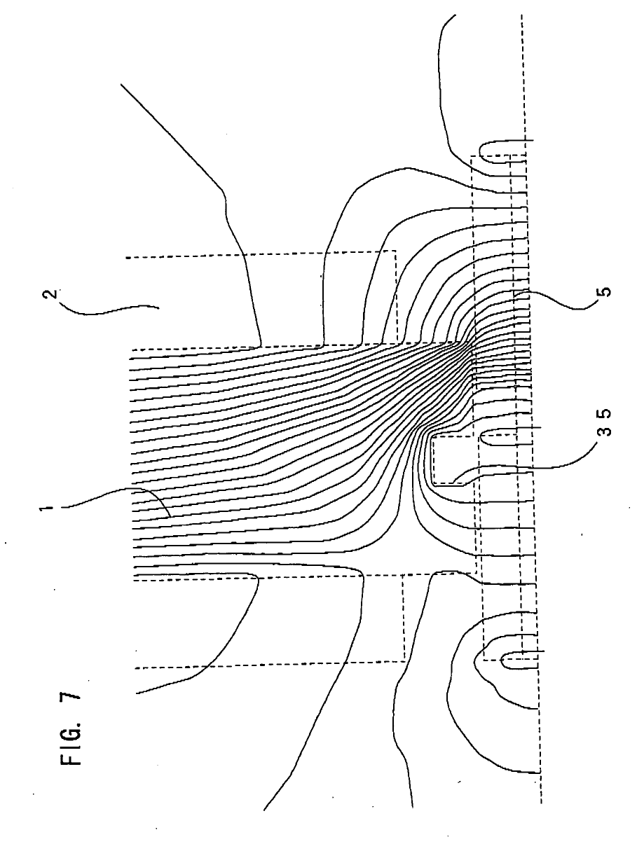

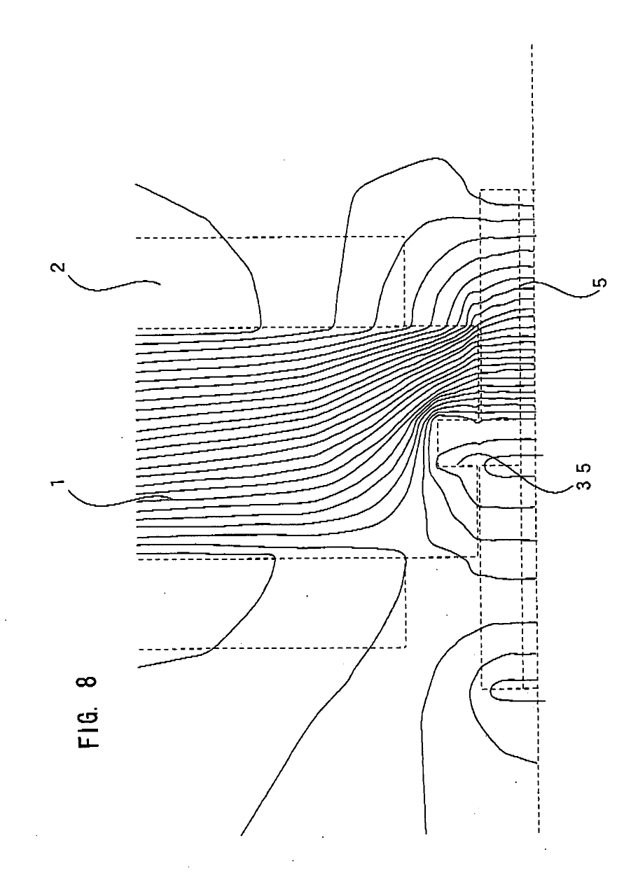

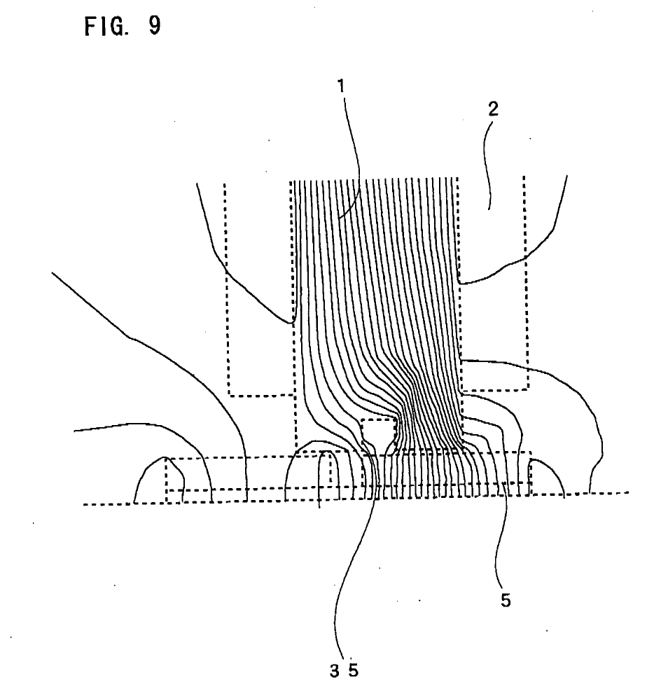

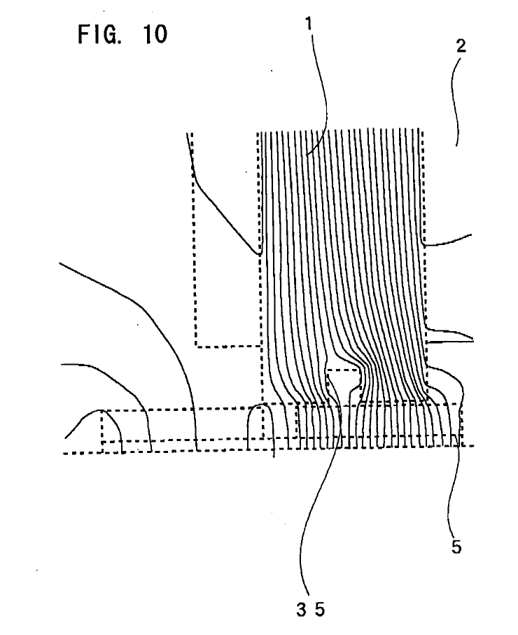

FIGS. 6-10 show the distribution of lines of magnetic force in a situation where the permanent magnets of the movable part are moved to the left in the figure, in the case where middle permanent magnet 52 does not exist, as a comparison example. In this case, lines of magnetic force that generate a force of magnetic attraction decreases as permanent magnet S moves, and therefore, the force of magnetic attraction decreases as permanent magnet 5 moves.

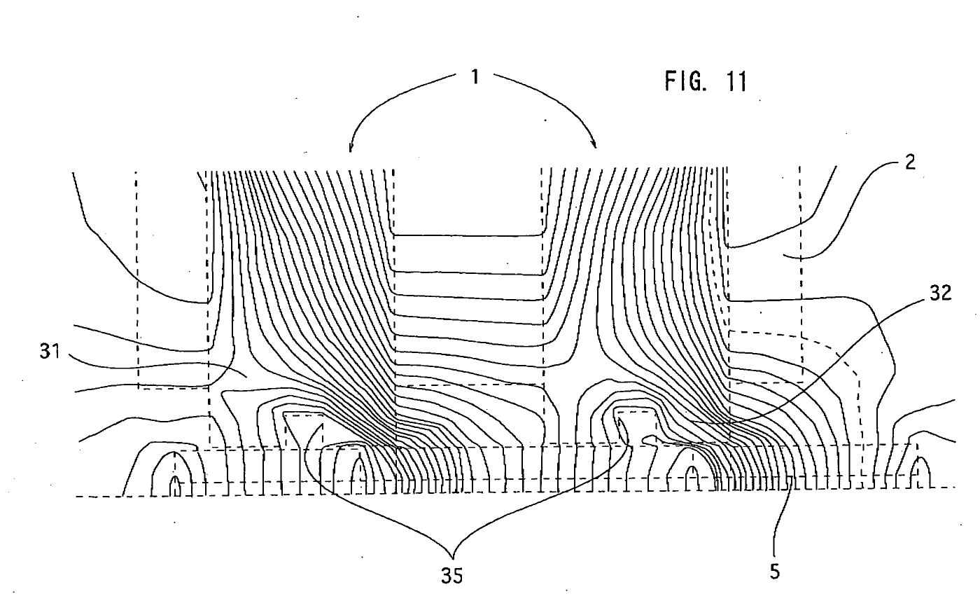

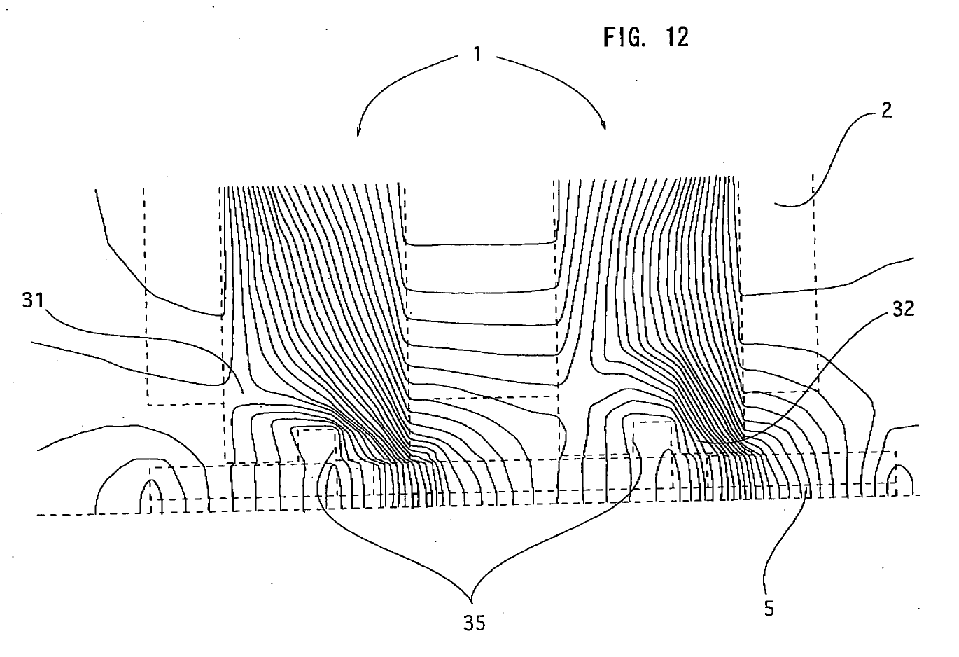

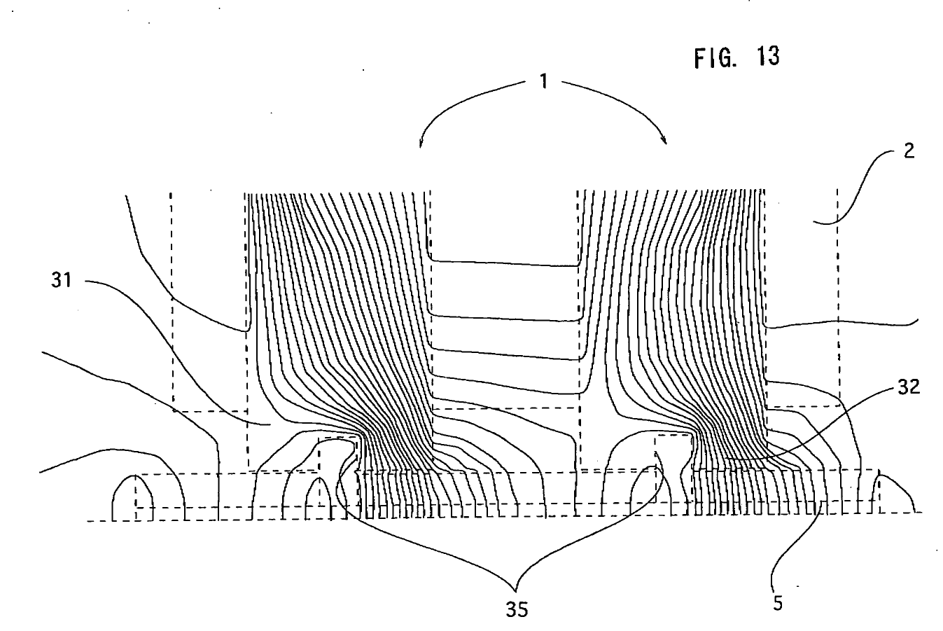

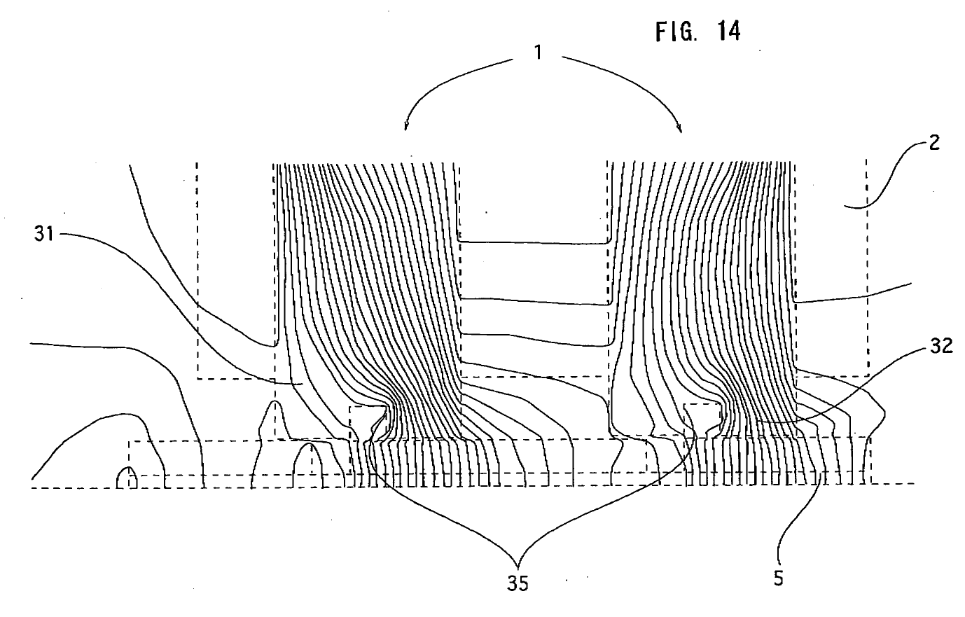

FIGS. 11-14 show the distribution of lines of magnetic force in a situation where the permanent magnets of the movable part move to the left in the figure, in the case where middle permanent magnet 52 exists. In this case, constant lines of magnetic force that generate a force of magnetic attraction are obtained in the portion of middle permanent magnet 52, irrespective of the movement of permanent magnet 5, and therefore, constant lines of magnetic force that generate a force of magnetic attraction, irrespective of the movement of permanent magnet 5, and a constant force of magnetic attraction is obtained.

In the present first embodiment, a support member is provided between two members, magnetic poles 31, 32, 33 and 34 of the electromagnet 3, and three permanent magnets 51, 52 and 53, and thereby, restriction of movement in the direction other than the movable directions is provided.

The component of the force of magnetic attraction that is parallel to the direction of movement from among the force of magnetic attraction is utilized as a driving force for the movement of the movable part, and the remaining components of the force of magnetic attraction that cross the movable direction are structurally offset or cancel out by the support members.

Accordingly, it is necessary to generate a magnetic flux that has components parallel to the movable direction between the members where a force of magnetic attraction is generated, in order to utilize the force of magnetic attraction as a driving force for the movement of the movable part.

The linear actuator according to the present first embodiment is the linear actuator wherein a number of magnetic poles 31, 32, 33 and 34 of electromagnet 3 where coil 2 is wound around iron core 1 of a magnetic material are provided so as to face each other with plurality of gaps, in a manner where the polarities N and S alternate at the time of excitation, the magnetic poles of a number of permanent magnets 5 that are aligned so as to form the movable member 4 are placed in positions that face the number of magnetic poles, and a magnetic flux that passes through the permanent magnet 5 that extends beyond portions where magnetic poles 31, 32, 33 and 34 of the electromagnet 3 are provided so as to face the portions is formed, generating an axis propelling force, and thereby, an effect is attained where a stable force of magnetic attraction in the direction of the stroke is implemented or obtained.

In addition, in the linear actuator according to the present first embodiment, notches 35 are formed in portions in the direction of the axis of magnetic poles 31, 32, 33 and 34 of the electromagnet 3 that face the magnetic poles of the permanent magnets 5, and the biased magnetic flux that avoids the notches 35 is formed within magnetic poles 31, 32, 33 and 34 of the electromagnet 3, and thereby, formation of a magnetic flux that passes through the permanent magnets 5 in the extended portions other than the portions where magnetic poles of the electromagnet 3 and the magnetic poles of the permanent magnets 5 face each other is accelerated, that is, the number of lines of magnetic force is increased, and therefore, an effect is gained or attained where the axis propelling force is enhanced.

Furthermore, in the linear actuator according to the present first embodiment, three permanent magnets 51, 52 and 53 are aligned between magnetic poles 31, 32, 33 and 34 of the adjacent electromagnets, and therefore, an effect is attained where stable reciprocating movement of the movable member 4 where magnetic poles of the permanent magnets 51, 52 and 53 are placed is obtained.

In addition, in a linear actuator according to the present first embodiment, magnetic poles of one permanent magnet 52 are placed so as to span between magnetic poles 31, 32, 33 and 34 of the adjacent electromagnets 3 at the time of full stroke, and therefore, an effect is attained where stable reciprocating movement of the movable member 4 is obtained.

### Second Embodiment

In a linear actuator according to the second embodiment, as shown in FIG. 1 to FIG. 17, a plurality of magnetic poles 31, 32, 33 and 34 of electromagnet 3 where coil 2 is wound around iron core 1 of a magnetic material are aligned so that the polarities N and S alternate at the time of excitation, and magnetic poles of permanent magnets 5 of which the number is smaller than magnetic poles 31, 32, 33 and 34 of electromagnet 3 by 1 are placed in positions that face the number of magnetic poles 31, 32, 33 and 34 of electromagnet 3, magnetic gaps of a constant distance are provided between the respective magnetic poles 31, 32, 33 and 34 of the electromagnet 3, on the side that faces permanent magnets 5 that form movable member 4, and one of the magnetic poles of the permanent magnet 52 are placed in a manner where one of the magnetic poles of the permanent magnet 52 span between respective magnetic poles 31, 32, 33 and 34 of the electromagnet 3 at the time of full stroke, and thus, the basic configuration is formed in the same manner as in the first embodiment, whereby the same parts are denoted by the same symbols, and the descriptions thereof are omitted.

A linear actuator of the present second embodiment is applied as an actuator for a pressure wave generator wherein permanent magnets of which the magnetic poles are opposite those of the adjacent permanent magnets are placed in positions that face magnetic poles at the ends of the lane of magnetic poles 31, 32, 33 and 34 of the electromagnet 3, on the side that faces the permanent magnets 5 in the direction of the axis, and that are adjacent to the permanent magnets 5, so that at least a portion of the permanent magnets 5 extends to the outside of the ends of the lane of magnetic holes 31, 32, 33 and 34 of the electromagnet 3 at the time of full stroke, as shown in FIG. 2.

Notches 35 are provided at the center of movable members 4 of magnetic poles 31, 32, 33 and 34 of the electromagnet 3 in the direction of the axis on the side that faces the permanent magnets 5, so that magnetic gaps are provided, and in addition, magnetic gaps are provided between the two adjacent permanent magnets from among aligned permanent magnets 51, 52 and 53.

Magnetic materials 61 are placed between respective magnetic poles 31, 32, 33 and 34 of electromagnet 3 on the side that does not face the permanent magnets 5, and thus, a magnetic circuit that connects respective magnetic poles 31, 32, 33 and 34 is provided.

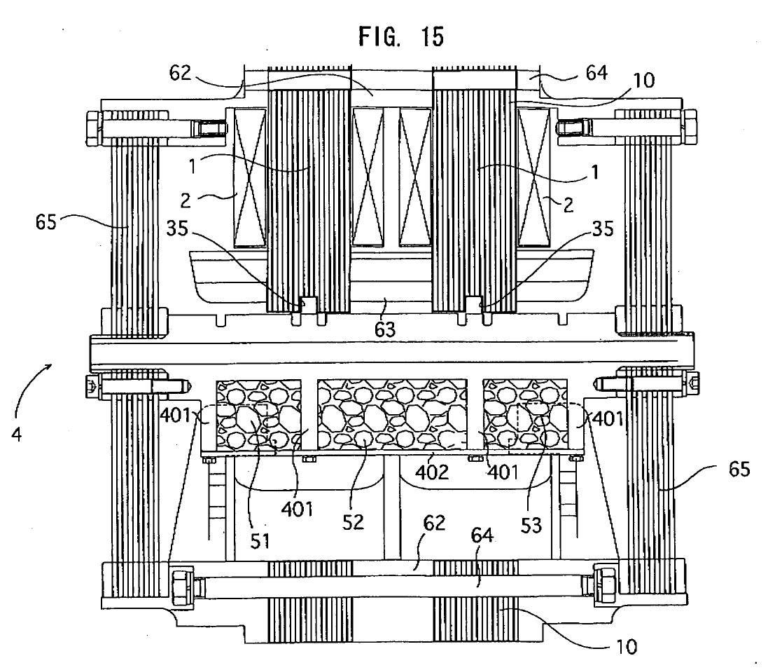

In the linear actuator according to the present second embodiment, as shown in FIG. 15, a plurality of magnetic poles 31, 32, 33 and 34 of electromagnet 3 where coil 2 is wound around iron core 1 of a magnetic material are provided in two stages that are parallel to each other at constant distances in the direction of the axis of the movable member 4, in a manner where the polarities N and S alternate at the time of excitation.

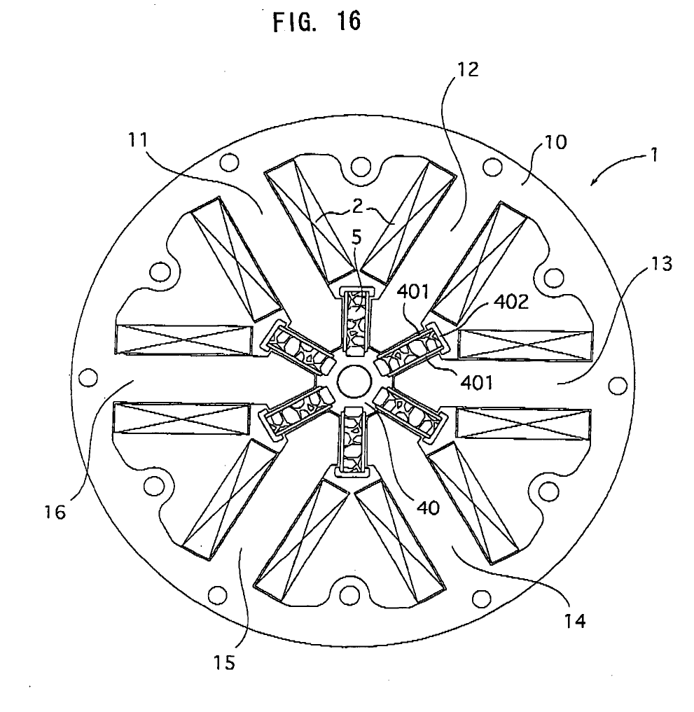

As shown in FIG. 16, first to sixth iron cores 11 to 16 are provided in a radial pattern at intervals of 60 degrees in the direction of the radius within an annular back yoke 10, and coils 2 are wound around parallel portions of respective iron cores 11 to 16.

Coils 2 of the plurality of poles are connected in series relative to the power supply, so that a coil for one pole is made of a plurality of coils connected in parallel. In the case of a moving coil, a large amount of coil can be wound in a limited space, increasing the ratio of line to volume, and therefore, the efficiency increases.

In the case of a moving coil, operation is not stable unless the respective coils are connected in series. This is because moving coils operate by means of a voltage (Fleming's law) and moving magnets operate by means of a current (direct drive by means of magnetic energy).

The iron cores 1 are provided in two stages parallel to each other at a constant distance away from each other as shown in FIG. 15, and support members 62 and 63 are, respectively, inserted and provided between the outer peripheral portion and the inner peripheral portion of the iron cores, and on both sides outside of the movable member 4 in the direction of the axis, and are fixed by penetrating bolts 64 so as to be pinched or clamped.

The shaft 40 made of a non-magnetic material that is used as the movable member 4 is supported at both ends by a pair of radial support members 65 that have been inserted between the two ends of support member 62 on the outer peripheral side that pinches outer peripheral portion 10 of the iron cores 1, as shown in FIG. 15, and the shaft 40 is provided in an elastic manner so as to freely reciprocate in the center portion of the iron cores 1.

Permanent magnets 5 are provided outside of the shaft 40 in the direction of the radius at intervals of 60 degrees, as shown in FIG. 16, and walls on both sides are formed so as to face each other at a constant microscopic distance at the center end portion in the approximate V shape of the iron cores.

The permanent magnets 5 are, as shown in FIG. 15 and FIG. 16, inserted between a pair of support members 401, one end of each of which is fixed to the shaft 40 and which have been provided at every predetermined distance in the direction of the axis of the shaft 40, and are supported by the shaft 40 by means of a connection member 402 that is fixed with bolts that extend in the direction of the axis of the shaft 40 that is linked to the other end of each of the pair of support members 401 without using an adhesive.

Namely, the permanent magnets 5 are fixed to support member 401 that has been provided on the outer surface of the permanent magnets 5, and the support member 401 is formed of a magnetic material, so that the density of the magnetic flux between the permanent magnets 5 and the electromagnet 3 is increased, in the configuration.

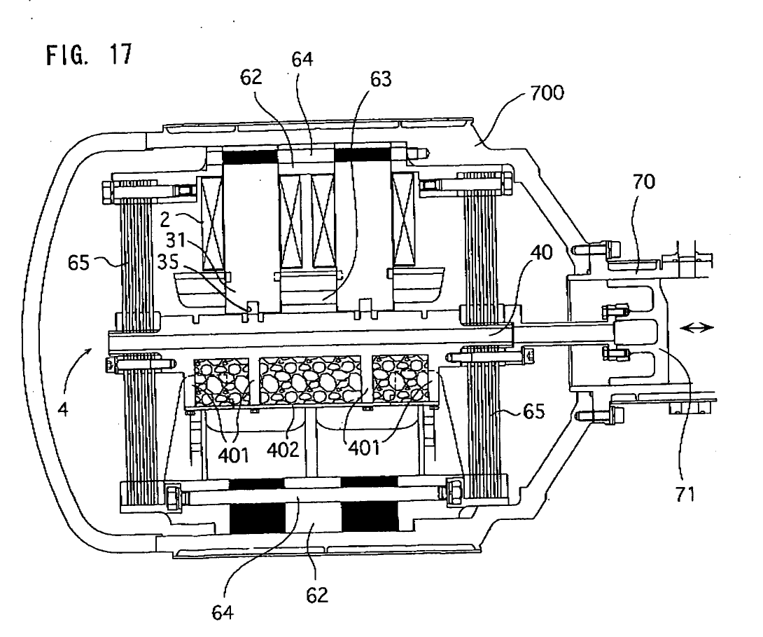

A piston 71 that reciprocates within a cylinder 70 that is linked to one end of a casing 700 that has been inserted and placed as shown in FIG. 17 with bolts is linked to the shaft 40 in a linear actuator according to the present second embodiment is formed so as to generate a pressure wave when the shaft 40 reciprocates in response to an electrical input that flows into the coils 2, and thereby, the piston reciprocates within the cylinder.

In the linear actuator according to the present second embodiment, a number of magnetic poles of electromagnet 3 where coil 2 is wound around iron core 1 of a magnetic material are aligned in a manner where the polarities N and S alternate at the time of excitation, and magnetic poles 31, 32, 33 and 34 of permanent magnets 5, of which the number is smaller than the number of magnetic poles of electromagnet 3 by 1, in positions that face the number of magnetic poles of electromagnet 3, where magnetic gaps having a constant distance are provided between the respective magnetic poles of the electromagnet 3 on the side that faces the permanent magnets 5, and the magnetic poles of the permanent magnets 5 are placed in a manner where magnetic poles of one permanent magnet 52 span between the respective magnetic poles of the electromagnets at the time of full stroke, and therefore, a magnetic flux that passes through the permanent magnets 5 which extend to the magnetic gaps other than the portions where magnetic poles of the electromagnet 3 are provided so as to face the portions is formed, generating an axis propelling force, and thereby, an effect is attained where a stable force of magnetic attraction in the direction of the stroke is obtained.

In the linear actuator according to the present second embodiment, permanent magnets of which the magnetic poles are opposite those of the adjacent permanent magnets are placed in positions that are adjacent to the permanent magnets 5, in positions that face the end magnetic poles in the direction of the axis of the lane of the magnetic poles of the electromagnet 3 on the side that faces the permanent magnets 5, in a manner where at least a portion of the permanent magnets 5 extends to the outside of the end portions of the lane or column of magnetic poles of the electromagnet 3 at the time of full stroke, and therefore, a magnetic flux that passes through the permanent magnets 51, 52 and 53 that extend to the outside from the end portions of the lane of magnetic poles of the electromagnet 3 is formed, generating an axis propelling force, and thereby, an effect is attained where a stable force of magnetic attraction in the direction of the stroke is obtained.

Furthermore, in the linear actuator according to the present second embodiment, notches 35 are provided at the center of magnetic poles 31, 32, 33 and 34 of the electromagnet 3 on the side that faces the permanent magnets 5, so as to provide magnetic gaps, and therefore, a biased magnetic flux that avoids the notches 35 that have been formed at the center within the magnetic poles of the electromagnet 3 is formed, and thereby, an effect is attained where the formation of a magnetic flux that passes through the permanent magnets 5 in the portions other than the portions where the magnetic poles of the electromagnet 3 and the magnetic poles of the permanent magnets 5 face each other is accelerated or improved, increasing an axis propelling force.

In addition, in the linear actuator according to the present second embodiment, magnetic gaps are provided between the adjacent permanent magnets 51, 52 and 53, and therefore, an effect is gained where the formation of a magnet flux that passes through the permanent magnets 51, 52 and 53 is improved.

Furthermore, in the linear actuator according to the present second embodiment, the magnetic materials 61 are placed between the respective magnetic poles of electromagnet 3 on the side that does not face the permanent magnets 5, so as to form a magnetic circuit that connects the respective magnetic poles, and therefore, an effect is attained where the formation of a magnetic flux that passes through the permanent magnets 5 in the portions other than the portions where the magnetic poles of the electromagnet 3 and the magnetic poles of the permanent magnets 5 face each other is accelerated or improved, increasing an axis propelling force.

In addition, in the linear actuator according to the present second embodiment, support member 401 and connection member 402 that is fixed with bolts are provided on the outer surface of the permanent magnets 5, so as to fix the permanent magnets 5, and therefore, an effect is attained where peeling and cracking of the permanent magnets 5 is prevented, in contrast to the prior art.

Furthermore, in the linear actuator according to the present second embodiment, the support member 401 is formed of a magnetic material, and the density of the magnetic flux between the permanent magnets 5 and the electromagnet 3 is increased in the configuration, and therefore, an effect is gained or attained where the generated axis propelling force is increased, and a still further stable force of magnetic attraction in the direction of the stroke is implemented or obtained.

When the shaft 40 reciprocates in response to an electrical input that is applied to the coils 2, the piston 71 reciprocates within the cylinder 70, because piston 71 that reciprocates within cylinder 70 is linked to the shaft 40 in the linear actuator according to the present second embodiment, which is thereby applied as the actuator for a pressure wave generator which generates pressure waves, and therefore, an effect is attained where stable pressure wave generation is made possible.

In addition, in the linear actuator according to the present second embodiment, the support member 401 is provided on the outer surface of the permanent magnets 5 so as to fix the permanent magnets 5, and therefore, an effect is attained where the support member 401 can be formed of a magnetic material, so that the density of the magnetic flux between the permanent magnets 5 and the electromagnet 3 can be increased.

Furthermore, in the linear actuator according to the present second embodiment, iron cores 1 and/or support member 62 of the iron cores 1 are made to make thermal contact with casing 700 which is a case, and therefore, an effect is gained where heat release or radiation is enhanced, and in addition, the same working effects as those of the first embodiment are attained.

The preferred embodiments of the present invention, as herein disclosed are taken as some embodiments for explaining the present invention. It is to be understood that the present invention should not be restricted by these embodiments and any modifications and additions are possible so far as they are not beyond the technical idea or principle based on descriptions of the scope of the patent claims.

The above embodiments are described as examples, and the present invention is not limited to these, but rather, an embodiment where wire materials of the coils that are wound around iron cores are bundled, an embodiment where coils in a plurality of stages are connected in parallel, and an embodiment where coils, each of which is for one pole of a permanent magnet, are connected in parallel, which is an extreme modification of a different type from the above-described embodiments and which is considered as providing a magnetic equivalent, can also be adopted.

### INDUSTRIAL APPLICABILLITY

A plurality of electromagnets where coils are wound around magnetic materials are provided so as to face each other in a manner where the polarities N and S of the electromagnets alternate at the time of excitation, and magnetic poles of a plurality of permanent magnets that are aligned so as to form a movable member are placed in positions that face the plurality of magnetic poles, wherein the permanent magnets extend beyond the portions where the magnetic poles of the electromagnets are provided so as to face.

Therefore, a magnetic flux that passes through the above-described extended portion of the permanent magnet is formed, and generating an axis propelling force, and thereby, an effect is attained where a stable force of magnetic attraction in the direction of the stroke is obtained.

1. A linear actuator, wherein a plurality of electromagnets where coils are wound around magnetic materials are provided so as to face each other in a manner where the polarities N and S of said electromagnets alternate at the time of excitation, and magnetic poles of a plurality of permanent magnets that are aligned so as to form a movable member are placed in positions that face the plurality of magnetic poles, wherein
said permanent magnets extend beyond the portions where said magnetic poles of said electromagnets are provided so as to face.

2. The linear actuator according to claim 1, wherein
a notch is formed on a portion in the direction of the axis of said magnetic poles of said electromagnets that face said magnetic poles of said permanent magnets, so that a magnetic flux is formed so as to pass said permanent magnets in the portions other than those where said magnetic poles of said electromagnets and said magnetic poles of said permanent magnets face each other.

3. The linear actuator according to claim 2, wherein
three permanent magnets are aligned between said magnetic poles of said adjacent electromagnets.

4. The linear actuator according to claim 3, wherein
said magnetic poles of one permanent magnet are placed so as to span said magnetic poles of said adjacent electromagnets at the time of full stroke.

5. A linear actuator, wherein
magnetic poles of a plurality of electromagnets where coils are wound around magnetic materials are aligned in a manner where the polarities N and S alternate at the time of excitation, and magnetic poles of permanent magnets of which the number is smaller than the number of magnetic poles of said electromagnets by 1 are aligned in positions that face said magnetic poles of said electromagnets,
magnetic gaps are provided between said respective magnetic poles of said electromagnets on the side that faces the permanent magnets, and
the magnetic poles of said permanent magnets are arranged so that one magnetic pole of said permanent magnets spans between said respective magnetic poles of said electromagnets at the time of full stroke.

6. The linear actuator according to claim 5, wherein
permanent magnets of which the magnetic poles are opposite that of adjacent permanent magnets are placed in positions adjacent to said permanent magnets, in a position that faces an end magnetic pole in the direction of the axis of the lane of the magnetic poles of said electromagnets on the side that faces said permanent magnets, and at least a portion of said permanent magnets extends to the outside of the end portion of the lane of the magnetic poles of said electromagnets at the time of full stroke.

7. The linear actuator according to claim 6, wherein
a notch is provided at the center of said magnetic poles of said electromagnets on the side that faces said permanent magnets, so that a magnetic gap is provided.

8. The linear actuator according to claim 7, wherein
a magnetic gap is provided between said adjacent permanent magnets.

9. The linear actuator according to claim 8, wherein
magnetic materials are placed between said respective magnetic poles of said electromagnets on the side that does not face said permanent magnets, so that a magnetic circuit which connects said respective magnetic poles is provided.

10. The linear actuator according to claim 9, wherein
a support member is provided on the outer surface of said permanent magnets, so as to fix said permanent magnets.

11. The linear actuator according to claim 10, wherein
said support member is formed of a magnetic material, so that the density of the magnetic flux between said permanent magnets and said electromagnets is increased.

12. The linear actuator according to claim 5, wherein
said linear actuator is applied as an actuator for a pressure wave generator.
